(19) United States
(12) Patent Application Publication
(10) Pub. No.: US 2013/0103349 A1
(43) Pub. Date: Apr. 25, 2013

(54) POWER SUPPLY UNIT WITH SERVICE LIFE EXPIRATION ALARM AND METHOD THEREOF

(71) Applicants: WEN-SEN HU, Shenzhen City (CN); YA-JUN PAN, Shenzhen City (CN); TING GE, Shenzhen City (CN)

(72) Inventors: WEN-SEN HU, Shenzhen City (CN); YA-JUN PAN, Shenzhen City (CN); TING GE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/314,193

(22) Filed: Dec. 8, 2011

(30) Foreign Application Priority Data
Oct. 25, 2011 (CN) 201110327310.0

(51) Int. Cl. G06F 19/00; H02H 7/10

(52) U.S. Cl. 702/182; 363/50

(57) ABSTRACT

A power supply unit includes a storage unit, a temperature detecting unit, a ripple voltage detecting unit, and a processor. The storage unit stores a conversion relationship between ripple voltages V in different temperature ranges and equivalent ripple voltages Vₛ at a standard temperature Tₛ. The temperature detecting unit and the ripple voltage detecting unit detects a temperature T and a ripple voltage V of an electrolytic capacitor of the power supply unit respectively. The processor acquires an initial ripple voltage Vᵢ of the electrolytic capacitor at an initial temperature Tᵢ, acquires a working ripple voltage V_{w} at a working temperature T_{w}, converts Vᵢ and V_{w} to equivalent ripple voltages Vᵢₛ and V_{ws} at the standard temperature Tₛ according to the relationship, compares V_{ws} with Vᵢₛ, and determines whether service life of the power supply unit is nearing its end.

### BACKGROUND

1. Technical Field

The present disclosure relates to power supply units with service life expiration alarm and a method thereof.

2. Description of Related Art

Power supply units supply power to electronic devices, such as database storage devices or computing devices. A power supply unit could shut down suddenly if the service life of the power supply unit reaches an end. This may result in problems, such as losing data being processed in the device or damaging the device. Therefore, monitoring of the service life of the power supply unit is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic, block diagram of a power supply unit with service life expiration alarm, in accordance with an exemplary embodiment.

FIG. 2 is a flowchart of a monitoring method to monitor a service life of the power supply unit of FIG. 1, in accordance with an exemplary embodiment.

### DETAILED DESCRIPTION

An Equivalent Series Resistance (ESR) of an electrolytic capacitor of a power supply unit (PSU) can be used to estimate the service life of the PSU. For example, when the electrolytic capacitor of a PSU is at a standard temperature, and the ESR of the PSU reaches one and a half time its initial value when the PSU was initially put into service, the service life of the PSU is nearing its end. One way to determine ESR of a PSU is by using the formula R=U/I, wherein U is a ripple voltage of the electrolytic capacitor of a PSU, I is a ripple current of the electrolytic capacitor, and R is

ESR of the electrolytic capacitor. When the PSU is in a stabile loop circuit, the value of I is considered to be constant, and the value of R has a linear relationship with the value of U, thus, the value of U can be used to estimate the service life of the PSU. In addition, because the value of ESR of a PSU is also relative to the temperature of the PSU, when estimating the service life of the PSU, the detected value of U of the electrolytic capacitor should be converted to an equivalent value at a standard temperature.

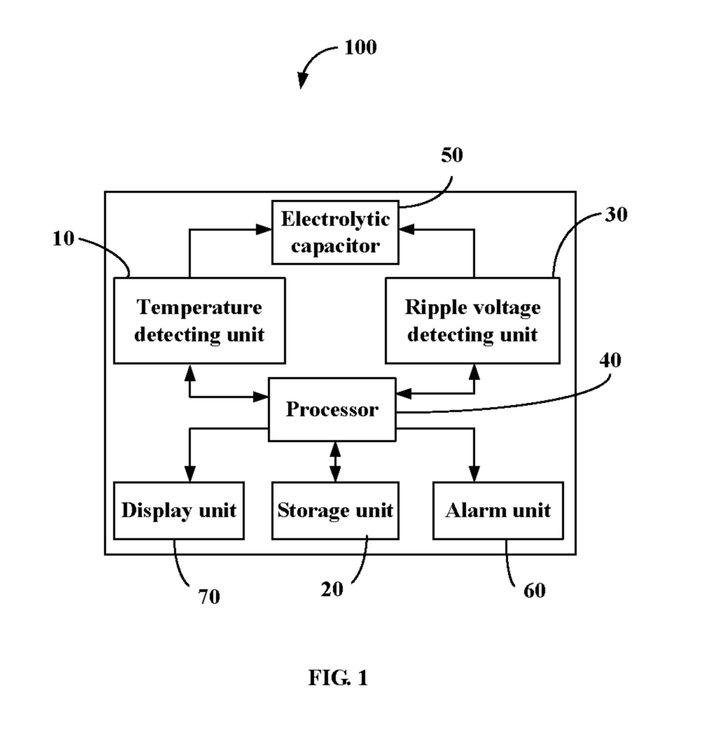

Referring to FIG. 1, a power supply unit (PSU) 100 includes a temperature detecting unit 10, a storage unit 20, a ripple voltage detecting unit 30, and a processor 40. The temperature detecting unit 10 detects the temperature T of an electrolytic capacitor 50 of the PSU 100. In the embodiment, the temperature detecting unit 10, such as a temperature sensor, is placed in the electrolytic capacitor 50. The storage unit 20 stores a conversion relationship between ripple voltages V in different temperature ranges and equivalent ripple voltages Vₛ at a standard temperature Tₛ. The conversion relationship is fixed after the PSU 100 is produced. The conversion relationship may be provided by a producer. The conversion relationship is shown as below.

| Temperature | Coefficient to convert a ripple voltage V in a temperature range |
|---|---|
| range | to an equivalent ripple voltage V_{S} at a standard temperature T_{S} |
| T1-T2 | n1 |
| T3-T4 | n2 |
| . . . | . . . |

For example, when a ripple voltage V detected at a current temperature T is 2V, and the temperature T falls into the temperature range TI-T2, the ripple voltage value V of the electrolytic capacitor 50 at the current temperature T can be converted to an equivalent ripple voltage value Vₛ at the standard temperature Tₛ using (2*nl)V. Thus, ripple voltages V at different temperatures T can be converted to the equivalent ripple voltage Vₛ at the standard temperature Tₛ.

The ripple voltage detecting unit 30 detects the ripple voltage V of the electrolytic capacitor 50.

The processor 40 controls the ripple voltage detecting unit 30 to detect an initial ripple voltage Vᵢ of the electrolytic capacitor 50 and the temperature detecting unit 10 to detect an initial temperature Tᵢ of the electrolytic capacitor 50 when the PSU 100 is initially put into service, and converts the initial ripple voltage Vᵢ at the initial temperature Tᵢ to an equivalent ripple voltage Viₛ at the standard temperature Tₛ according to the relationship stored in the storage unit 20. In the embodiment, in order to get a more accurate value of the initial ripple voltage value Vᵢ, after the PSU 100 is initially started, the ripple voltage value of the electrolytic capacitor 50 is detected several times over a predetermined period and an average value of the detected ripple values is taken as the initial ripple voltage value Vᵢ. In this embodiment, after the initial ripple voltage Vᵢ is detected, the processor 40 converts the initial ripple voltage Vᵢ at the initial temperature Tᵢ to an equivalent ripple voltage Vᵢₛ at the standard temperature Tₛ, and then stores the equivalent ripple voltage Vᵢₛ in the storage unit 20.

When the PSU 100 is running, the processor 40 periodically controls the ripple voltage detecting unit 30 to detect a working ripple voltage V_{w} of the electrolytic capacitor 50 and the temperature detecting unit 10 to detect a working temperature T_{w} of the electrolytic capacitor 50, and converts the working ripple voltage V_{w} at the working temperature T_{w} to an equivalent ripple voltage V_{ws} at the standard temperature Tₛ according to the relationship.

The processor 40 compares the equivalent ripple voltage V_{ws} with the equivalent ripple voltage Vᵢₛ, and determines the service life of the PSU 100 is nearing its end if the coefficient of V_{ws} divided by Viₛ reaches a predetermined value, such as about 1.3-1.5. In this embodiment, the PSU 100 further includes an alarm unit 60 to alert a user if the coefficient of the V_{ws} divided by Vᵢₛ reaches a predetermined percentage, such as 95% of the predetermined value.

The PSU 100 further includes a display unit 70 to display information about the service life of the PSU 100.

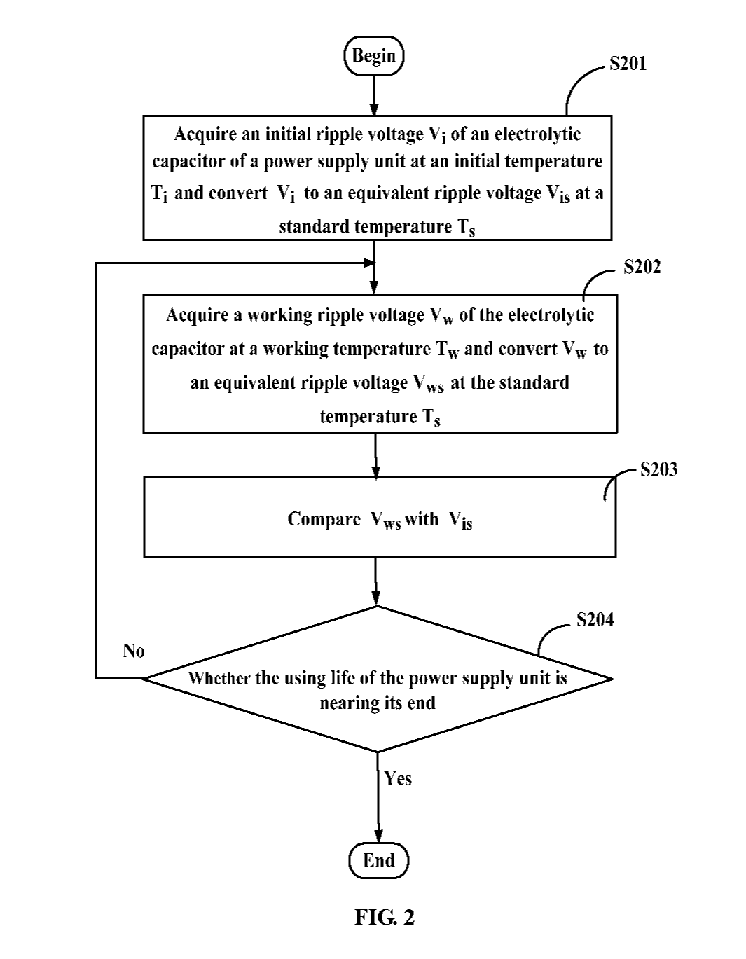

Referring to FIG. 2, a flowchart of a monitoring method to monitor the service life of the power supply unit is shown.

In step S201, the processor 40 controls the ripple voltage detecting unit 30 to detect an initial ripple voltage Vᵢ of the electrolytic capacitor 50 of the PSU 100 and the temperature detecting unit 10 to detect an initial temperature Tᵢ of the electrolytic capacitor 50 when the PSU 100 is initially put into service, and converts the initial ripple voltage Vᵢ at the initial temperature Tᵢ to an equivalent ripple voltage Vᵢₛ at the standard temperature Tₛ according to the relationship.

In step S202, the processor 40 periodically controls the ripple voltage detecting unit 30 to detect a working ripple voltage V_{w} of the electrolytic capacitor 50 and the temperature detecting unit 10 to detect the working temperature T_{w} of the electrolytic capacitor 50 when the PSU 100 is running, and converts the working ripple voltage V_{w} at the working temperature T_{w} to an equivalent ripple voltage V_{ws} at the standard temperature Tₛ according to the relationship.

In step S203, the processor 40 compares the equivalent ripple voltage V_{ws} with the equivalent ripple voltage Vᵢₛ.

In step S204, the processor 40 determines whether the service life of the PSU 100 is nearing its end by comparing the coefficient of V_{ws} divided by Vᵢₛ with a predetermined value, and if the coefficient is equal to or greater than the predetermined value, the service life of the PSU 100 is nearing its end, and the procedure goes to an end, otherwise, the procedure goes to step S202.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A power supply unit with service life expiration alarm, the power supply unit comprising:
a storage unit storing a conversion relationship between ripple voltages V of an electrolytic capacitor of the power supply unit in different temperature ranges and equivalent ripple voltages Vₛ of the electrolytic capacitor at a standard temperature Tₛ and a plurality of applications;
a temperature detecting unit to detect a temperature T of the electrolytic capacitor;
a ripple voltage detecting unit to detect a ripple voltage V of the electrolytic capacitor; and
a processor to execute the plurality of applications, wherein the plurality of applications comprise instructions executable by the processor to:
control the ripple voltage detecting unit to detect an initial ripple voltage Vᵢ of the electrolytic capacitor and the temperature detecting unit to detect an initial temperature Tᵢ of the electrolytic capacitor when the power supply unit is initially put into service, and convert the initial ripple voltage Vᵢ at the initial temperature Tᵢ to an equivalent ripple voltage Vᵢₛ at the standard temperature Tₛ according to the relationship;
control the ripple voltage detecting unit to detect a working ripple voltage V_{w} of the electrolytic capacitor and the temperature detecting unit to detect a working temperature T_{w} of the electrolytic capacitor when the power supply unit is running, and convert the working ripple voltage V_{w} at the working temperature T_{w} to an equivalent ripple voltage V_{ws} at the standard temperature Tₛ according to the relationship;
compare the equivalent ripple voltage V_{ws} with the equivalent ripple voltage Vᵢₛ; and
determine a service life of the power supply unit nearing its end if the coefficient of the equivalent ripple voltage V_{ws} divided by the equivalent ripple voltage Vᵢₛ reaches a predetermined value.

2. The power supply unit as described in claim 1, wherein the predetermined value is about 1.3-1.5.

3. The power supply unit as described in claim 1, wherein the equivalent ripple voltage Vᵢₛ is stored in the storage unit.

4. The power supply unit as described in claim 1, wherein after the power supply unit is initially put into service, the ripple voltage value of the electrolytic capacitor is detected several times over a predetermined period and an average value of the detected ripple values is taken as the initial ripple voltage value Vᵢ.

5. The power supply unit as described in claim 1 further comprising a display unit to display information about the service life of the power supply unit.

6. The power supply unit as described in claim 1 further comprising an alarm unit to alert a user if the coefficient of the V_{ws} divided by Vᵢₛ reaches a predetermined percentage of the predetermined value.

7. A monitoring method for monitoring service life of an power supply unit, the power supply unit comprising a storage unit, a temperature detecting unit and a ripple voltage detecting unit, the storage unit storing a conversion relationship between ripple voltages V of an electrolytic capacitor of the power supply unit in different temperature ranges and equivalent ripple voltages Vₛ of the electrolytic capacitor at a standard temperature Tₛ, the temperature detecting unit detecting a temperature T of the electrolytic capacitor, the ripple voltage detecting unit detecting a ripple voltage V of the electrolytic capacitor, the monitoring method comprising:
controlling the ripple voltage detecting unit to detect an initial ripple voltage Vᵢ of the electrolytic capacitor and the temperature detecting unit to detect an initial temperature Tᵢ of the electrolytic capacitor when the power supply unit is initially put into service, and convert the initial ripple voltage Vᵢ at the initial temperature Tᵢ to an equivalent ripple voltage Vᵢₛ at the standard temperature Tₛ according to the relationship;
controlling the ripple voltage detecting unit to detect a working ripple voltage V_{w} of the electrolytic capacitor and the temperature detecting unit to detect a working temperature T_{w} of the electrolytic capacitor when the power supply unit is running, and convert the working ripple voltage V_{w} at the working temperature T_{w} to an equivalent ripple voltage V_{ws} at the standard temperature Tₛ according to the relationship;
comparing the equivalent ripple voltage V_{ws} with the equivalent ripple voltage Vᵢₛ; and
determining that a service life of the power supply unit is near its end if the coefficient of the equivalent ripple voltage V_{ws} divided by the equivalent ripple voltage Vᵢₛ reaches a predetermined value.

8. The monitoring method as described in claim 7, wherein the predetermined value is about 1.3-1.5.

9. The monitoring method as described in claim 7, wherein after the power supply unit is initially put into service, the ripple voltage value of the electrolytic capacitor is detected several times over a predetermined period and an average value of the detected ripple values is taken as the initial ripple voltage value Vᵢ.
